(19) United States
(12) Patent Application Publication
(10) Pub. No.: US 2009/0286147 A1
(43) Pub. Date: Nov. 19, 2009

(54) Composite porous membrane, method of producing composite porous membrane, and battery separator, battery and capacitor using the same

(76) Inventors: Atsushi Nakajima, Otsu-shi (JP); Cyuji Inukai, Otsu-shi (JP); Michihiko Irie, Otsu-shi (JP); Masanori Nakamura, Otsu-shi (JP); Jun Yamada, Otsu-shi (JP)

Correspondence Address: KENYON & KENYON LLP, 1500 K STREET N.W., SUITE 700, WASHINGTON, DC, 20005, US

(21) Appl. No.: 12/153,323

(22) Filed: May 16, 2008

(51) Int. Cl. H01M 2/16; B32B 27/08; B32B 5/32; C08J 7/02

(52) U.S. Cl. 429/145; 428/316.6; 428/315.9; 428/220; 427/80

(57) ABSTRACT

The present invention provides a composite porous membrane suited for a separator for a battery having excellent ion permeability, low pore blocking temperature, and high membrane breakage temperature by compositing resin porous membranes having different melting points (or softening points) without using a termocompression bonding method or a method of directly applying a solution to the substrate by using a composite porous membrane containing a porous membrane A of a resin having a melting point of 150° C. or less and a porous membrane B of a resin having a glass transition temperature of more than 150° C. integrated with the porous membrane A, wherein both a superficial side of the porous membrane B and an interfacial side with the porous membrane A of the porous membrane B have a three-dimensional network structure.

### BACKGROUND OF THE INVENTION

1. Field of the Invention

The present invention relates to a composite porous membrane having both a pore blocking function and excellent resistance to membrane breakage at a high temperature. More specifically, the present invention relates to a composite porous membrane which is useful as a separator for a lithium ion battery with high safety and charging-discharging reaction stability, having excellent ion permeability, and realizing both pore blocking function at 150° C. or less and heat resistant membrane breakage temperature of 200° C. or more, and further to a battery or a capacitor using the same.

2. Description of the Background Art

A porous membrane (microporous membrane) made of a thermoplastic resin is widely used as materials intended for separation, selective permeation and isolation of substances, such as separators for a battery used, for example, in a lithium secondary battery, a nickel-hydrogen battery, a nickel-cadmium battery or a polymer battery, separators for an electrolytic capacitor, various filters such as a reverse osmosis membrane filter, an ultrafiltration membrane filter, or a microfiltration membrane filter, moisture permissive water-proof clothing and medical materials. In particular, a porous membrane (microporous membrane) made of polyethylene is favorably used as a separator for a lithium ion secondary battery because it has a pore blocking effect that blocks current at a temperature of about 120 to 150° C. to suppress an excess increase in temperature during an abnormal increase in temperature of a battery, as well as it has an excellent electric insulation, ion permeability when it is impregnated with an electrolytic solution, and excellent resistance to electrolytic solution and resistance to oxidation. However, when temperature continuously increases after blocking of pores for some reason, the membrane may break at a certain temperature due to a decrease in viscosity of melted polyethylene forming the membrane and contraction of the membrane. Further, when the membrane is left still under a certain high temperature, it may break after a lapse of certain time due to a decrease in viscosity of melted polyethylene forming the membrane and contraction of the membrane. This phenomenon is not limited to the case of polyethylene, but is inevitable at a temperature the melting point or more of the resin forming the porous membrane even when other thermoplastic resin is used.

In particular, a separator for a lithium ion battery is closely related to battery characteristics, battery productivity and battery safety, so that excellent mechanical characteristics, heat resistance, permeability, size stability and pore blocking characteristics (shutdown characteristics), melt membrane breakage characteristics (melt down), and the like, are requested. For these reasons, various examinations have been made to improve the heat resistance. For example, Japanese Patent Laying-Open No. 2004-363048 discloses the attempt of improving heat resistance by laminating a heat resistant barrier layer film and a polyethylene porous membrane by thermocompression bonding, and for example, Japanese Patent Laying-Open No. 2003-171495 discloses improvement of heat resistance by giving heat resistant coating inside and both faces of a polyethylene porous membrane by dipping (impregnating) the polyethylene porous membrane in a heat resistant resin solution. Further, for example, Japanese Patent Laying-Open No. 2004-152675 reports the method of laminating a heat resistant resin porous layer by a wet membrane forming method after applying a heat resistant resin solution to the polyethylene porous membrane.

However, in the method of bonding a heat resistant film having punched using laser beams, linear pores are inevitably formed from a front face to a back face, and these crater-like pores are distributed over a wide area, so that it is impossible to form a porous layer in the form of fine network similar to that of a current polyolefin porous membrane. Such a phase structure is generally known to significantly accelerate generation of dendrite because charging and discharging reaction occurs locally in the pores.

Further, when a composite membrane is produced by laminating a heat resistant porous membrane of polyimide, polyamideimide, polyamide and the like and a polyolefin porous membrane, it is difficult to form the porous membrane by the same drawing elongation method as in the case of polyolefin porous membrane because the glass transition temperature of a heat resistant resin is very high, and heat deterioration of a resin also occurs at a temperature around glass transition temperature, and hardening occurs by a self cross-linking reaction at a high temperature.

Further, it is very difficult to execute drawing elongation after bonding the heat resistant porous membrane and the polyolefin porous membrane to each other because there is a large difference in softening temperature. That is, it is necessary to draw the composite porous membrane at a temperature that will not allow both of the porous layers to express a pore blocking function, so that only the combination in which glass transition temperatures are very close (for example, difference in melting point therebetween is 50° C. or less) is industrially acceptable. Any composite porous membranes for separator that are widely used in an industrial field have combinations of two or three layers of polyethylene and polypropylene.

Further, as to the method of thermocompression bonding heat a resistant film punched by laser beams or the like, significant deterioration in air permeability is inevitable because an opening area in the film itself is small, and most of the pores are blocked by blocking of a polyethylene surface at the time of thermocompression bonding. In order to solve this problem, it is necessary to make porosity and surface porosity of the porous membrane to be combined higher, however, it accompanies the problem of embrittlement of mechanical property, decrease insulation and difficulty in fabrication of thin membrane. For example, Japanese Patent Laying-Open No. 2004-363048 does not clearly show the solution to these problems.

As to the method of coating by dipping (impregnating) a polyolefin porous membrane in a heat resistant resin solution, it is possible to improve the heat resistance and reduce the bowing caused by a symmetrical phase structure because heat resistant porous layers can be formed inside and on both sides of the polyolefin porous membrane. However, it is inevitable that a heat resistant resin porous phase is formed inside the polyolefin porous membrane as well. As a result, communicating holes inside the polyolefin are blocked over most parts, so that not only significant deterioration in permeability but also significant reduction in a pore blocking function which is the most important function determining safety of a separator (blocking of communication holes by melting of polyolefin, and resulting inhibition of ion permeability) is significantly reduced is inevitable. For example, Japanese Patent Laying-Open No. 2003-171495 completely lacks the description about these problems.

Also known is a method of forming a heat resistant porous phase by a wet membrane forming method after applying a heat resistant resin solution to a polyolefin porous membrane, however, when this method is used, the coating solution internally permeates to a superficial layer part of the polyolefin porous membrane, inevitably leading deterioration in air permeability and reduction in a pore blocking function. Further, since permeation of the coating solution is controlled by the weight and thixotropy of the coating solution, and capillary phenomenon caused by micropores of the polyolefin porous membrane, various physical properties of a producible composite porous membrane are largely restricted, and fundamental solution is difficult.

### SUMMARY OF THE INVENTION

The present invention has been devised to solve the above problems, and it is an object of the present invention to provide a composite porous membrane which is suited for a separator for a battery having excellent permeability, low pore blocking temperature and high membrane breakage temperature by combining resin porous membranes having different melting points (or softening points) without using a thermocompression bonding method or a method of directly applying a solution to a substrate.

The inventors of the present invention have intensively studied to solve the above problems. As a result, the present invention is completed. That is, the present invention relates to a composite porous membrane having a pore blocking function and excellent resistance to membrane breakage at a high temperature, and a method of producing a composite porous membrane, and has the following characteristics.

The composite porous membrane of the present invention is a composite porous membrane including a porous membrane A of a resin having a melting point of 150° C. or less and a porous membrane B of a resin having a glass transition temperature of more than 150° C. integrated with porous membrane A, wherein both a superficial side of porous membrane B and an interfacial side with porous membrane A of porous membrane B have a three-dimensional network structure.

The composite porous membrane of the present invention is a composite porous membrane including porous membrane A of a resin having a melting point of 150° C. or less and porous membrane B of a resin having a glass transition temperature of more than 150° C. integrated with porous membrane A, wherein the air permeability of the entire composite porous membrane is twice or less the air permeability of porous membrane A, and is 50 to 1000 sec/100 cc Air, and the total membrane thickness is 40 μm or less.

According to the present invention, it is possible to provide a separator that is suited for a nonaqueous electrolyte secondary battery or a capacity, realizing high membrane breakage temperature and excellent safety without impairing ion permeability and a low-temperature pore blocking function that are inherently possessed by porous membrane A.

In the composite porous membrane of the present invention as described above, it is preferred that a difference between pore blocking temperature and heat resistant membrane breakage temperature measured at a temperature increasing rate of 30° C./min is 50° C. or more, and the pore blocking temperature is 150° C. or less, and the heat resistant membrane breakage temperature is 200° C. or more.

In the composite porous membrane of the present invention as described above, it is preferred that the porosity of porous membrane A is 30 to 70%, and the porosity of porous membrane B is 30 to 90%.

In the composite porous membrane of the present invention as described above, it is preferred that the average pore size of porous membrane A is 0.01 to 1.0 μm, and the average pore size of porous membrane B is 0.1 to 5.0 μm.

In the composite porous membrane of the present invention as described above, it is preferred that porous membrane A contains 50% by weight or more of ultrahigh molecular weight polyolefin having a mass average molecular weight of 3×10⁵ or more.

In the composite porous membrane of the present invention as described above, it is preferred that porous membrane B is formed of at least one resin selected from the group consisting of a polyacetal resin, a polybutylene terephthalate resin, a polyethylene terephthalate resin, a polyphenylene sulfide resin, a polyether ketone resin, a polyetherimide resin, a fluorine resin, a polyether nitrile resin, pa olycarbonate resin, a polyphenylene ether resin, a polysulfone resin, a polyether sulfone resin, a polyallylate resin, a polyimide resin, a polyamide imide resin, a polyamide resin and a cellulose resin. In this case, it is more preferred that porous membrane B is formed of a polyamide resin, a polyimide resin or a polyamide imide resin having a logarithmic viscosity of 0.5 dl/g or more.

In the composite porous membrane of the present invention as described above, it is preferred that porous membrane B is formed by a phase separation method.

The present invention also provides a separator for a battery or a capacitor using the composite porous membrane of the present invention as described above.

The present invention also provides a nonaqueous electrolyte secondary battery or a capacity using the separator of the present invention as described above.

The present invention also provides a method of producing a composite porous membrane that includes the steps of applying resin varnish having a glass transition temperature of more than 150° C. to a substrate; contacting the resin varnish with a poorer solvent than that contained in the varnish to make the resin varnish into a gel containing the solvent; transferring the gel to porous membrane A composed of a resin having a melting point of 150° C. or less; and washing and drying the porous membrane A.

In the production method of composite porous membrane of the present invention as described above, it is preferred that the substrate is polypropylene, polyethylene, polyethylene terephthalate or stainless. When the substrate is polypropylene, polyethylene or polyethylene terephthalate, it is preferably subjected to a corona discharge treatment.

In the production method of composite porous membrane of the present invention as described above, it is preferred that the substrate is in the form of an endless belt.

In the production method of composite porous membrane of the present invention as described above, it is preferred that porous membrane B is formed by making a substrate pass through an atmosphere at 10 to 30° C. and 50 to 90% RH over 10 to 60 seconds after applying a resin solution capable of forming porous membrane B to the substrate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a section view schematically showing a composite porous membrane 1 of the present invention.

FIG. 2 is a SEM photograph of the superficial side of a porous membrane B of a composite porous membrane obtained in Example 1.

FIG. 3 is a SEM photograph of the interfacial side with a porous membrane A in porous membrane B of the composite porous membrane obtained in Example 1.

FIG. 4 is a SEM photograph of the superficial side of a porous membrane B of a composite porous membrane obtained in Example 4.

FIG. 5 is a SEM photograph of the interfacial side with a porous membrane A in porous membrane B of the composite porous membrane obtained in Example 4.

FIG. 6 is a SEM photograph of the superficial side of a porous membrane B of a composite porous membrane obtained in Example 6.

FIG. 7 is a SEM photograph of the interfacial side with a porous membrane A in porous membrane B of the composite porous membrane obtained in Example 6.

FIG. 8 is a SEM photograph of the superficial side of a porous membrane B of a composite porous membrane obtained in Comparative example 2.

FIG. 9 is a SEM photograph of the superficial side of a porous membrane B of a composite porous membrane obtained in Comparative example 3.

### DESCRIPTION OF THE PREFERRED EMBODIMENTS

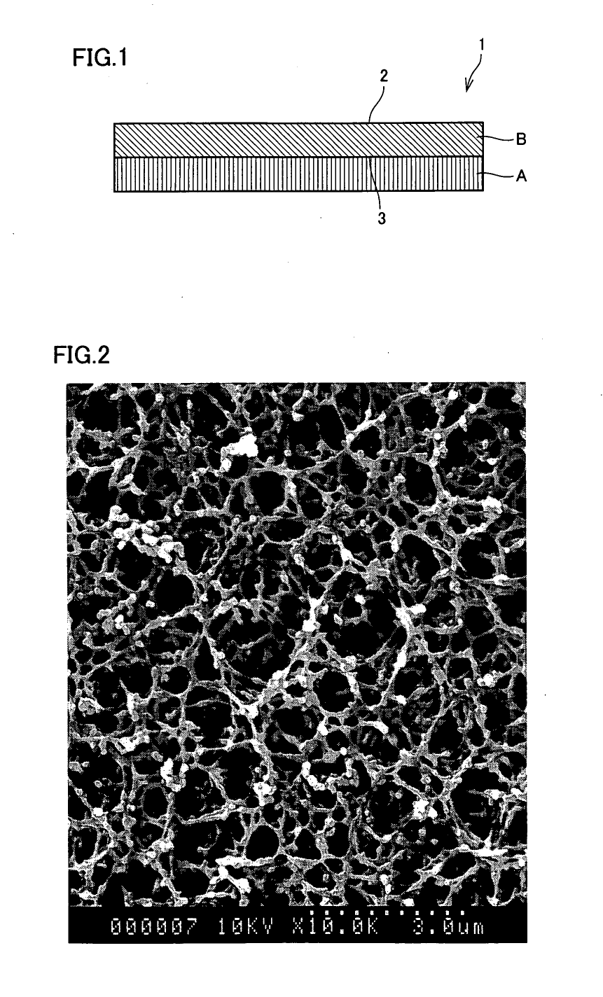

FIG. 1 is a section view schematically showing a composite porous membrane 1 of the present invention. Composite porous membrane 1 of the present invention is a composite porous membrane including a porous membrane A of a resin having a melting point of 150° C. or less and a porous membrane B of a resin having a glass transition temperature of more than 150° C. integrated with porous membrane A, wherein both of a superficial side 2 of porous membrane B and an interfacial side 3 with porous membrane A of porous membrane B have a three-dimensional network structure.

The expression “three-dimensional network structure” used herein refers to a so-called “net” structure and represents the condition that a network structure is formed not only in the planer direction (face direction) but also in the horizontal direction (thickness direction) by a resin solidified in a fibrous form. A porous membrane having a three-dimensional network structure does not have definite surface coating, and concretely exhibits a surface form as shown in FIGS. 2 to 7 as will be described later.

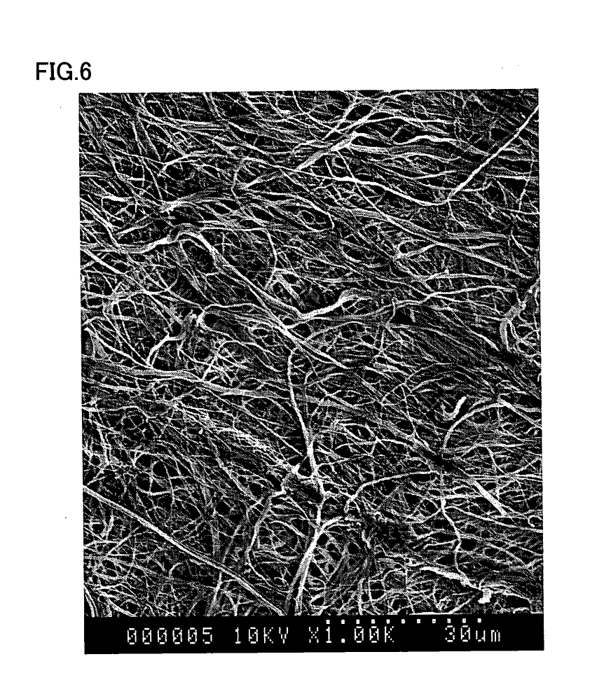

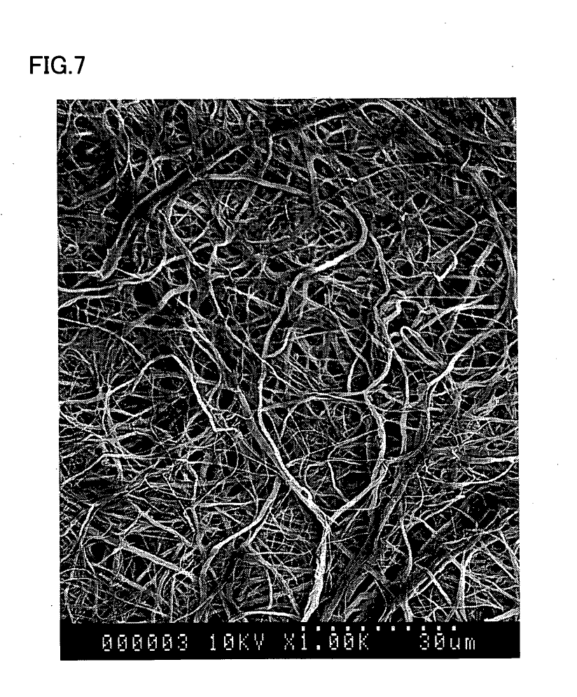

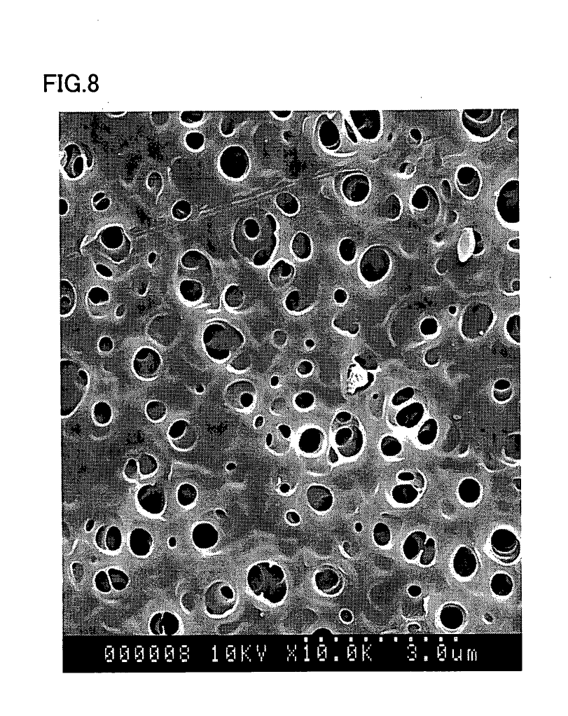

In the three-dimensional network structure, the resin solidified into a fibrous form itself functions as a column to provide a porous membrane with mechanical strength such as void retention and self-support, and preferably has a length ranging from 0.1 to 5.0 μm, and a thickness ranging from 0.01 to 1.0 μm. It is preferred that a branching part does not have a certain shape, but has generally an irregular spherical shape of 0.1 to 3.0 μm in diameter. As will be described later, when nonwoven fabric is used for formation of porous membrane B (FIGS. 6 and 7), fibers spread two-dimensionally lengthwise, and this case also applies to a “three-dimensional network structure” used herein in terms that fibers get entangled three-dimensionally, and fibers solidify while intersecting points of fibers are in close contact each other.

As a network structure, for example, a cross-linking structure, a mesh structure, a structure like spider's nest, a sponge-like structure and the like can be recited.

The greatest effect of employing a “three-dimensional network structure” is the ability of integrating openings of porous membrane A and openings of porous membrane B while they are not blocked with each other. As a result, it is possible to provide a separator suited for a non-aqueous electrolyte secondary battery or a capacitor, realizing an excellent balance between pore blocking temperature and heat resistant membrane breakage temperature, and high safety, without impairing air permeability of the entire composite porous membrane thus obtained.

The expression “integrated” used herein refers to the condition that porous membrane A and porous membrane B are partly or entirely in close contact with each other, rather than the condition that porous membrane A and porous membrane B are merely stacked with each other. The contact at the interface may be rigid, however, the contact strength is preferably such that the contact is easily cleared by hands or by using a cellophane tape. When the contact is too rigid, the air permeability tends to increase, whereas when the close contact is not ensured at all, displacement may occurs between porous membrane A and porous membrane B during assembling of a non-aqueous secondary battery or a capacitor.

In the composite porous membrane of the present invention, both of superficial side 2 of porous membrane B and interfacial side 3 with porous membrane A of porous membrane B have a three-dimensional network structure. This is because in a composite porous membrane produced through a conventionally known method, in particular, the interfacial side with porous membrane A of porous membrane B does not have a three-dimensional network structure, which may result in deterioration in air permeability of the entire composite porous membrane.

In the composite porous membrane of the present invention as described above, it is preferred that the air permeability of the entire composite porous membrane is not twice or less the air permeability of porous membrane A, and is within a range of 50 to 1000 sec/100 cc Air, and the total membrane thickness is 40 μm or less. The present invention also provides a composite porous membrane including porous membrane A of a resin having a melting point of 150° C. or less and porous membrane B of a resin having a glass transition temperature of more than 150° C. integrated with porous membrane A, wherein the air permeability of the entire composite porous membrane is twice or less the air permeability of porous membrane A, and is 50 to 1000 sec/100 cc Air, and the total membrane thickness is 40 μm or less.

It is necessary that porous membrane A has a function of blocking pores in an abnormal condition such as a charging and discharging reaction. Therefore, the melting point (softening point) of a resin forming porous membrane A is preferably 70 to 150° C., more preferably 80 to 140° C., and most preferably 100 to 130° C. When melting point of the resin forming porous membrane A is less than 70° C., practicability is poor because a pore blocking function may appear in a normal use condition to disable use of the battery, whereas when the melting point of the resin forming porous membrane A exceeds 150° C., sufficient safety may not be ensured because a pore blocking function appears after an abnormal reaction has adequately proceeded.

Thickness of porous membrane A is preferably 5 to 35 μm, more preferably 10 to 30 μm, and most preferably 10 to 20 μm. When the thickness of porous membrane A is smaller than 5 μm, it is impossible to have practical membrane strength and a pore blocking function, whereas when the thickness is larger than 35 μm, safety may not be ensured because shunt occurs due to melting contraction because the volume occupied by porous membrane B is small.

The air permeability of porous membrane A is preferably 50 to 800 sec/100 cc Air, more preferably 50 to 500 sec/100 cc Air, and most preferably 50 to 300 sec/100 cc Air, and the porosity is preferably 30 to 70%, more preferably 35 to 60%, and most preferably 40 to 55%. In both cases of an air permeability of porous membrane A of higher than 800 sec/100 cc Air and a porosity of porous membrane A of lower than 30%, battery charging and discharging characteristics, in particular, ion permeability (charging and discharging operation voltage), and life time of a battery (closely related to retention amount of electrolyte) are not satisfactory, and outside these ranges, a function of the battery may not be sufficiently exerted. On the other hand, in both of the cases where the air permeability is lower than 50 sec/100 cc Air, and where the porosity of porous membrane A is higher than 70%, sufficient mechanical strength and insulation are not obtained, so that shunt is more likely to occur in charging and discharging.

Further, as to the surface condition of porous membrane A, adherence with porous membrane B tends to increase when the average roughness is 0.01 to 0.5 μm. When the average roughness of porous membrane A is less than 0.01 μm, the effect of improving adherence is not obtained, and when the average roughness of porous membrane A exceeds 0.5 μm, a decrease in mechanical strength of porous membrane A and transfer of irregularity to the superficial face of porous membrane B may occur.

Since porous membrane B has a function of supporting and reinforcing porous membrane A by its heat resistance, the glass transition temperature of the constituting resin is preferably 150° C. or more, more preferably 180° C. or more, and most preferably 210° C. or more, and the upper limit is not necessarily provided. When the glass transition temperature of the resin forming porous membrane B is higher than decomposition temperature, it suffices that the decomposition temperature falls within the above range. When the glass transition temperature of the resin forming porous membrane B is lower than 150° C., sufficient heat resistant membrane breakage temperature is not obtained, and high safety may not be ensured.

The thickness of porous membrane B is preferably 1 to 35 μm, more preferably 2 to 20 μm, and most preferably 3 to 10 μm. When the thickness is smaller than 1 μm, membrane breakage strength and insulation may not be ensured when porous membrane A melts and contracts at a temperature of the melting point or more, whereas when the thickness is larger than 35 μm, an abnormal reaction may not be controlled since the proportion occupied by porous membrane A is small, and a sufficient pore blocking function is not obtained.

The air permeability of porous membrane B is preferably 1 to 500 sec/100 cc Air, more preferably 1 to 200 sec/100 cc Air, and most preferably 1 to 50 sec/100 cc Air, and the porosity is preferably 30 to 90%, more preferably 40 to 80%, and most preferably 50 to 70%. In both cases where the air permeability of porous membrane B is lower than 1 sec/100 cc Air, and where the porosity of porous membraneB is higher than 90%, it is impossible to ensure membrane breakage strength of composite porous membrane when porous membrane A melts and contracts at a temperature of the melting point or more, so that high safety may not be ensured. On the other hand, in both cases where the air permeability of porous membrane B is higher than 500 sec/100 cc Air, and where the porosity of porous membrane B is lower than 30%, air permeability when it is composited with porous membrane A tends to exceed twice the air permeability of porous membrane A, and sufficient battery characteristics may not be obtained.

As to the average pore size of porous membrane A, it is preferably 0.01 to 1.0 μm, more preferably 0.05 to 0.5 μm, and most preferably 0.1 to 0.3 μm because it significantly influences on a pore blocking rate. When the average pore size of porous membrane A is smaller than 0.01 μm, the possibility that the air permeability is greatly deteriorated during compositing increases, whereas when the average pore size of porous membrane A is larger than 1.0 μm, such phenomena may occur that response of pore blocking phenomenon to temperature is slow, and that pore blocking temperature by a temperature increasing rate shifts to the higher temperature side.

As to the average pore size of porous membrane B, it is preferably 0.1 to 5.0 μm, more preferably 0.3 to 4.0 μm, and most preferably 0.5 to 3.0 μm because it mainly influences on the ion permeability of porous membrane A, and supporting force and membrane breakage strength during melt and contraction. When the average pore size of porous membrane B is smaller than 0.1 μm, the air permeability of the obtained composite porous membrane may possibly exceed twice that of porous membrane A, whereas when the average pore size is of porous membrane B is larger than 5.0 μm, porous membrane A that melts and contracts cannot be sufficiently supported, and shunt may not be suppressed.

The thickness of the entire composite porous membrane thus obtained is desirably 40 μm or less, preferably 6 to 40 μm, more preferably 10 to 30 μm, and most preferably 10 to 20 μm. When the thickness of the entire composite porous membrane is smaller than 6 μm, it may be difficult to ensure sufficient mechanical strength and insulation, whereas when the thickness is larger than 20 μm, it may be difficult to avoid a decrease in volume because the electrode area which can be charged in the container is reduced.

Further, the air permeability of the composite porous membrane is one of the most important characteristics, and is preferably 50 to 1000 sec/100 cc Air, more preferably 50 to 600 sec/100 cc Air, and most preferably 50 to 300 sec/100 cc Air. When the value of air permeability is lower than 50 sec/100 cc Air, sufficient insulation is not obtained, and clogging of contaminants, shunt, and membrane breakage may be caused, whereas when the value is higher than 1000 sec/100 cc Air, membrane resistance is high, so that charging and discharging characteristics, and life-time characteristic within practically usable ranges may not be obtained.

As the resin forming porous membrane A, polyolefin, in particular, polyethylene is preferred, because it has a pore blocking effect that blocks electric current and controls a temperature increase at a temperature of about 120 to 150° C. during an abnormal temperature increase of a battery, in addition to the basic characteristics including having ion permeability as a result of dipping in an electrolyte, having excellent electrolyte resistance and oxidation resistance, and having appropriate strength.

Further, from the view point of process operability and mechanical strength that bears various external pressure occurring at the time of winding with electrode, for example, tensile strength, modulus of elasticity, elasticity, puncture strength and the like, the mass average molecular weight is preferably 3×10⁵ or more, more preferably 4×10⁵ or more, and most preferably 5×10⁵ or more. When such a resin is used, ultrahigh molecular weight polyolefin having a mass average molecular weight within the above range is contained preferably in an amount of 50% by weight or more, and more preferably in an amount of 60% by weight or more. When the content of ultrahigh molecular weight polyolefin having a mass average molecular weight of 3×10⁵ or more is less than 50% by weight, deterioration of mechanical physical properties when the temperature increases over the pore blocking temperature is significant because of low melting viscosity, and melt breakage of a membrane may be caused due to winding pressure and burr in the electrode end part even at a temperature around pore blocking temperature.

As to a layer structure of porous membrane A, it differs depending on the production method. Any layer structure appropriate for the purpose may be provided by selecting the production method as far as the above various characteristics are satisfied. Specific examples of the production method include foaming method, phase separation method, melt and re-crystallization method, drawing opening method, powder sintering method and so on.

As to the resin forming porous membrane B, it is preferably at least one resin selected from the group consisting of a polyacetal resin, a polybutylene terephthalate resin, a polyethylene terephthalate resin, a polyphenylene sulfide resin, a polyether ketone resin, a polyetherimide resin, a fluorine resin, a polyether nitrile resin, a polycarbonate resin, a polyphenylene ether resin, a polysulfone resin, a polyether sulfone resin, a polyallylate resin, a polyimide resin, a polyamide imide resin, a polyamide resin and a cellulose resin. In particular, among these heat resistant resins, from the view points of heat resistance, electrolyte resistance, convenience owing to good solubility to a highly polar solvent, and affinity to an electrolyte, amorphous a polyamide resin, a polyamideimide resin or a polyimide resin is preferably used.

When porous membrane B is formed of a polyamide resin, a polyamide imide resin or a polyimide resin, its logarithmic viscosity is preferably 0.5 dl/g or more, more preferably 0.7 dl/g or more, and most preferably 0.9 dl/g or more. It is not necessary to particularly determine the upper limit of logarithmic viscosity, however, from the view point of operability such as solvent solubility and solution viscosity at the time of flow casting, it is preferably 3.0 dl/g or less, more preferably 2.5 dl/g or less, and most preferably 2.0 dl/g or less.

The phase structure of porous membrane B differs depending on the production method. Any layer structure appropriate for the purpose may be provided by selecting the production method as far as the above various characteristics are satisfied. Specific examples of the production method include a foaming method, a phase separation method, a melt and re-crystallization method, a drawing opening method, a powder sintering method and so on. Among these, a phase separation method is preferred from the points of uniformization of micropores and costs. Porous membrane B may be in the form of non-woven fabric. Concretely, a wet non-woven fabric, and non-woven fabrics obtained by thermal bond, span lace, span bond, and electro spinning and melt blow are particularly preferred because they allow reduction of a membrane thickness while keeping uniformity of a membrane thickness and a pore distribution.

In the composite porous membrane of the present invention, after flow-casting a solution in which a resin forming porous membrane B is dissolved on a substrate, the resin is allowed to deposit gently by addition to or contact with a poor solvent. As the substrate that can be used at this time, generally used film, such as a polyethylene terephthalate resin film, a polyethylene resin film, and a polypropylene resin film, or a stainless sheet can be exemplified. Further, when the above resin film is used as a substrate, use of a corona discharge processed surface is preferable because adhesion is weak in peeling off porous membrane B in the next step.

The substrate on which porous membrane B is to be formed is preferably in the form of endless belt. This is because the time for causing deposition of a resin of porous membrane B can be conveniently adjusted by a position of a coating blade, and hence processing speed (line speed) can be increased. Also, process using a generally used roll coater is available, however, there is inconvenience that the time for causing deposition of a resin of porous membrane B should be adjusted by the roll diameter of applicator roll and the line speed.

It is also possible to conduct wet membrane forming without peeling off the substrate to which porous membrane B is to be formed. When this method is used, it is possible to produce a composite porous membrane even when soft porous membrane A that has low modulus of elasticity and causes necking by tension in the case where processing is used. Concretely, such characteristics of excellent process operability are expected that wrinkle or bending is not generated in the composite porous membrane during passage through the guide roll, and that curling in a dry condition is reduced. At this time, the substrate and the composite porous membrane may be rolled up concurrently, or the substrate and the composite porous membrane may be rolled up on separate take-up rolls after passage of the drying step, however, the latter rolling up method is preferred because misalignment in roll is less likely to occur.

As the poor solvent, water is industrially most preferred. Further, in order to control the deposition speed of a resin by moisturizing process, various water-soluble glycol component, water-soluble polymer component, or oligomer component thereof may be added as an auxiliary agent for phase separation. As a specific method of adding moisture, moisturizing process, and wet process using an aqueous solution containing organic solvent can be exemplified, however, for forming uniform phase structure, moisturizing process is preferred. The phase structure may be appropriately changed by changing moisturizing a wind volume, water amount, wind speed, wind direction, temperature and time, and may be freely adjusted depending on the use purpose, operation efficiency and space. Particularly preferred is to apply a resin solution capable of forming porous membrane B on a substrate, followed by passage in an atmosphere at 10 to 30° C. and at 50 to 90% RH over 10 to 60 seconds, from the view point of forming an uniform porous structure. When the above range is not satisfied, a film having little pores in the superficial face may be formed, or the possibility of contacting with porous membrane A while a sufficient porous structure is not formed is increased. This may result in significant deterioration in air permeability or porosity of the obtained composite porous membrane. Porous membrane B formed by the above process exhibits a gel state (non-fluid state) containing a solvent.

Next, on the porous membrane B in a gel state obtained as described above, porous membrane A is bonded so that no foams are contained. As a bonding method, the method of bonding films coming from two directions on the face of one metal roll is preferred from the view point of damages exerted on a film, and uniformity of porous membrane B, and prevention of porous membrane B from entering porous membrane A.

Next, from the substrate or metal roll, the composite porous membrane in which porous membrane A and porous membrane B which are bonded is peeled off. At this time, porous membrane B is transferred to porous membrane A over the entire face, and a composite porous membrane in an unwashed state is obtained. This is because a part of porous membrane B is appropriately cut into pores of porous membrane A to express an anchoring effect.

Further, the above unwashed porous membrane is dipped into an aqueous solution containing 1 to 20% by weight, more preferably 5 to 15% by weight of a good solvent for the resin forming porous membrane B, and a washing step using pure water, and a drying step using hot blast at 100° C. or less are conducted, to obtain a final composite porous membrane.

When porous membrane B fails to be transferred to porous membrane A with a good yield and in a good quality for the reason that the thickness of the membrane is large, or a layer structure that is nonuniform in the thickness direction is intended to be formed, the purpose may be achieved by dipping in a solidifying bath without being peeled off from the substrate, and then peeling off the substrate.

In order to improve the affinity of a composite porous membrane to an electrolyte solution, known techniques such as a sulfonation treatment, a fluorine gas treatment, a graft polymerization treatment, a discharge treatment, a hydrophilic resin imparting treatment, a surfactant treatment and the like may be used. A discharge treatment includes corona discharge, plasma discharge, glow discharge, an electron ray treatment and the like, and a plasma treatment is particularly preferred because hydrophilization can be effected to the internal. Further, as the hydrophilic resin, carboxymethyl cellulose, polyvinyl alcohol, polyacrylic acid and the like can be recited. For the surfactant treatment, anionic surfactants such as an alkaline metal salt of higher fatty acid, an alkyl sulfonic acid salt, and a sulfosuccinic acid ester salt, and nonionic surfactants such as polyoxyethylene ether are effective.

Also an electron conductive polymer such as polythiophene, polyacetylene, and polyaniline may be additionally used. Among these, polyaniline is useful because the dependency of conductivity on humidity is small, and dispersibility and compatibility with respect to a polyamide resin, a polyamide imide resin and a polyimide resin are excellent. In particular, organic solvents in which oxidization polymerized polyaniline derivative is doped with an inorganic acid or organic protonic acid dopant such as dodecylbenzene sulfonic acid, or those dissolved or dispersed in water are preferred.

The phase separation auxiliary agent used in the present invention is at least one selected from water, alkyl glycols such as ethylene glycol, propylene glycol, tetramethylene glycol, neopentyl glycol and hexandiol, polyalkylene glycols such as polyethylene glycol, polypropylene glycol and polytetramethylene glycol, water-soluble polyester, water-soluble polyurethane, polyvinyl alcohol, carboxymethyl cellulose and the like, and the adding amount is preferably 10 to 90% by weight, more preferably 20 to 80% by weight, and most desirably 30 to 70% by weight, relative to the solution weight of a coating solution.

By mixing such a phase separation auxiliary agent with a coating solution, it is possible to control mainly air permeability, a surface open area ratio, and a formation rate of a layer structure. When the adding amount is less than the above range, significant increases in a phase separation rate is not always observed, whereas when the adding amount is larger than the above range, the coating solution sometimes gets clouded in the step of mixing, so that a resin component may deposit.

As a solvent that can be used for dissolving a resin in production of porous membrane B, N,N-dimethylacetamide (DMAc), N-methyl-2-pyrrolidone (NMP), hexamethyltriamide phosphate (HNPA), N,N-dimethyl formamide (DMF), dimethylsulfoxide (DMSO), y-butylolactone, chloroform, tetrachloroethane, dichloroethane, 3-chloronaphthalene, para-chlorophenol, tetralin, acetone, acetonitrile and the like can be recited, which may be arbitrarily selected in accordance with the solubility of a resin.

In the composite porous membrane of the present invention, a composite porous membrane may be formed by using a polyolefin porous layer that is slit in an intended width, or may be subsequently processed on line in forming a polyolefin porous layer. The term “on-line” used herein refers to the means capable of obtaining an objective composite porous membrane by sequentially overlaying porous membrane B after a production step of a polyolefin porous layer (concretely drying step after washing), followed by solidification, washing, and slitting steps. Conducting the above on-line application enables mass production, which provides a great merit in a cost aspect.

The composite porous membrane obtained in the present invention is excellent in heat resistance and electrolyte resistance, however, it is also possible to additionally use a hardening agent when improvement in tensile strength, or further reduction in coefficient of melt contraction is intended. As the hardening agent, an epoxy resin, a melamine resin, an isocyanate compound having two or more functionalities can be recited. A resin solution in which at least one kind selected from the above hardening agents is mixed is laminated on polyolefin porous layer as in the manner as described above, and the hardening reaction can be promoted by utilizing heating in the drying step.

As for washing at the time of wet membrane formation, general measure such as UV irradiation or bubbling may be used. Further, in order to keep concentration in each bath constant and increase the washing efficiency, it is effective to remove the solution inside the porous membrane between baths. Concretely, the method of pushing out a solution inside the porous layer by means of air or inert gas or the method of mechanically squeezing out the solution inside the membrane with the use of a guide roll can be recited.

The composite porous membrane produced according to the effect of the present invention is preferably stored in dry condition, however, when storing in absolute dry condition is difficult, it is preferred to conduct a drying treatment under reduced pressure at 100° C. or less directly before use.

In the composite porous membrane of the present invention, it is preferred that a difference between pore blocking temperature and heat resistant membrane breakage temperature measured at a temperature increasing rate of 30° C./min is 50° C. or more, and the pore blocking temperature is 150° C. or less, and the heat resistant membrane breakage temperature is 200° C. or more. Here, the term “pore blocking (shutdown)” refers to the phenomenon that communication holes are blocked by melting of the resin forming the porous membrane, and ions are prevented from transmitting through the separator. The term “pore blocking temperature” refers to the temperature at which electric resistance of a separator starts increasing due to pore blocking. Further, the term “melt membrane breakage (melt down)” refers to the phenomenon that the resin forming a separator is melt or softened so that the separator is no longer able to exert an insulating function between electrodes. The term “heat resistant membrane breakage temperature” refers to the temperature at which electric resistance of a separator starts significantly decreasing due to membrane breakage by melting as the heating and temperature increase are made exceeding the pore blocking temperature.

The pore blocking function is a necessary function for ensuring safety of a lithium ion secondary battery, and it is necessary that the function is expressed at a temperature lower than about 160° C. which is an ignition point of lithium metal. On the other hand, the temperature increase inside the battery due to abnormal reaction at the time of charging and discharging is very rapid, so that the inertia temperature increase may last at about 30 to 40° C. (overshoot phenomenon) even if the pore blocking function is expressed. Therefore, it is preferred that the heat resistant membrane breakage temperature is more than the blocking temperature by 50° C. or more.

In a large-size lithium ion secondary battery, it is known that the internal temperature of a battery increases rapidly to 400 to 500° C. from a temperature of 200° C. or more, due to the phenomenon called “heat runaway” resulting from shunt between electrodes by melt membrane breakage. Therefore, if the heat resistant membrane breakage temperature is 200° C. or more, it is possible to further prevent an abnormal temperature increase, and significantly improve safety of the battery.

The difference between pore blocking temperature and heat resistant membrane breakage temperature is preferably 50° C. or more, assuming that temperature increase in an actual battery, the pore blocking temperature and heat resistant membrane breakage temperature are measured at a temperature increasing rate of 30° C./min as described above, and it is preferred that the pore blocking temperature is 150° C. or less and the heat resistant membrane breakage temperature is preferably 200° C. or more.

The composite porous membrane of the present invention may be used as a separator for a battery or a capacitor including a nickel-hydrogen battery, a nickel-cadmium battery, a nickel-zinc battery, a silver-zinc battery, a secondary battery such as a lithium secondary battery, or a lithium polymer secondary battery, and a plastic film capacitor, a ceramic capacitor, an electrolyte capacitor, an electric double-layered capacitor and the like, and in particular preferably used as a separator of a lithium secondary battery. As for the structure of the capacitor, any types including a single-sheet type, a winding type, a penetration type, a lamination type, an electrolyte type, and an electric double-layered type are possible. In the following, explanation will be made while taking a lithium secondary battery as an example.

In a lithium secondary battery, a cathode and a anode are stacked with a separator interposed therebetween, and the separator contains electrolyte solution (electrolyte). Structure of electrode is not particularly limited, and may be a known structure. For example, an electrode structure (coin type) in which a disc-like cathode and anode are opposite to each other, an electrode structure in which a planner cathode and anode are alternately laminated (lamination type), and an electrode structure in which a band-like cathode and anode are wound while they are overlapped (winding type) can be employed.

A cathode typically has a collector and a cathode active substance layer containing cathode active substances capable of occluding and discharging lithium ions formed on its surface. As the cathode active substance, inorganic compounds such as transition metal oxide, composite oxide of lithium and transition metal (lithium composite oxide), and transition metal sulfide can be recited, and as the transition metal, V, Mn, Fe, Co, Ni and the like can be exemplified. As a preferred example of lithium composite oxide among the cathode active substance, lithium nickelate, lithium cobaltate, lithium manganate, layered lithium composite oxide based on α-NaFeO₂ type structure are exemplified.

Anode has a collector and an anode active substance layer containing anode active substances formed on its surface. As the anode active substance, carbon-based materials such as natural graphite, artificial graphite, cokes, and carbon black can be exemplified. Electrolyte solution is obtained by dissolving a lithium salt in an organic solvent. As the lithium salt, LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, LiN(C₂F₅SO₂)₂, LiPF₄(CF₃)₂, LiPF₃(C₂F₅)₃, a lithium salt of lower aliphatic carboxylic acid, and LiAlCl₄ can be exemplified. These may be used solely or in combination of two or more kinds. As the organic solvent, ethylene carbonate, organic solvents having a high boiling point and a high dielectric constant such as propylene carbonate, ethylmethyl carbonate and y-butylolactone, and organic solvents having a low boiling point and a low viscosity such as tetrahydrofuran, 2-methyltetrahydrofuran, dimethoxyethane, dioxolane, dimethyl carbonate, and diethyl carbonate can be exemplified. These may be used solely or in combination of two or more kinds. In particular, since an organic solvent having a high dielectric constant has high viscosity, and an organic solvent having a low viscosity has low dielectric constant, it is preferred to use combination of these organic solvents.

In assembling a battery, a separator (composite porous membrane) is impregnated with an electrolyte solution. This imparts ion permeability to the separator. Usually, an impregnation treatment is conducted by dipping a composite porous membrane in an electrolyte solution at a normal temperature. For example, in assembling a cylindrical battery, first, a cathode sheet, a separator (composite porous membrane), and an anode sheet are stacked in this order, and the resultant laminate is wound up from one end, to produce a winding type electrode device. Then this electrode device is inserted into a battery can, and impregnated with the above electrolyte solution, and then a battery cap serving also as a cathode terminal having a safety valve is caulked via a gasket, to give a battery.

In the following, the present invention will be concretely described by way of examples, however, the present invention is not limited in any respects to these examples. Measurements in examples are determined in the following manners.

1. Logarithmic Viscosity

A solution dissolving 0.5 g of polymer in 100 mL of NMP was measured by using an Ubbelohde viscometer at 25° C.

2. Concentration of Nonvolatile Content

First, 0.5 to 1.0 g of a resin solution was accurately weighed on an aluminum foil that had been weighed in advance, and dried for 2 hours at 220° C. using a commercially available hot blast drier, and then cooled to around room temperature in a desiccator. Then the product including the aluminum foil was weighed, and the weight of the aluminum foil was subtracted from the resultant weight to determine weight of the deposited resin. Then concentration of nonvolatile content was determined from the following formula:

Concentration of nonvolatile content (%)=[1−{(weight of solution before drying (g)−weight of deposit after drying (g)/weight of solution before drying (g))]×100

3. Glass Transition Temperature

A resin solution, or a resin solution in which only a porous membrane B is dissolved by dipping a composite porous membrane in a good solvent was applied on PET film (E5001 available from TOYOBO Co., Ltd.) or polypropylene film (pi-wren-OT, available from TOYOBO Co., Ltd.) with an appropriate gap using an applicator, and peeled off after predrying at 120° C. for 10 minutes, and then further dried in vacuo at 200° C. for 12 hours while it is fixed with a heat resistant adhesion tape in an appropriate size of a metal frame, to obtain a dry film. A test piece of 4 mm wide and 21 mm long was cut out from the obtained dry film, and measurement was conducted while increasing the temperature from room temperature to 450° C. at a temperature increasing rate of 4° C./minutes by using a dynamic viscoelasticity measuring apparatus with a measurement length of 15 mm (DVA-220 available from ITK Co. Ltd (Japan)) at 110 Hz. At a refraction point of storage modulus of elasticity (E′), temperature at a crossing point between an extended line of base line below glass transition temperature, and a tangent line showing the maximum inclination above refraction point was read as glass transition temperature.

4. Observation Under Scanning Electron Microscope (SEM)

Observation of the surface of the composite porous membrane was conducted by measuring a test piece that is fixed on a measurement cell with a double-sided tape, and vapor deposited in vacuo for several minutes with platinum or gold, at appropriate magnification. On interfacial side of porous membrane B contacting with a porous membrane A, an adhesion tape was attached to porous membrane B of a composite porous membrane, and only porous membrane B was peeled off slowly (about 0.1 m/min) in the vertical direction with care so that agglutination breakage would not occur, and peeling surface at this time was observed. Achievement of intended interfacial peeling was determined based on the fact that porous membrane B was not left, by SEM observation of porous membrane A after peeling. As to microsurface in which observation under SEM is difficult, a test piece was observed using a field-emission type scanning electron microscopy (FE-SEM) after conducting a similar metal deposition treatment.

5. Average Pore Size

Arbitrary 10 points on the image obtained in SEM observation were selected, and the average value of the pore size in these 10 points was determined as an average pore size of the test piece.

6. Air Permeability

Using a Gurley type Densometer Model B available from Tester Sangyo Co., Ltd., the composite porous membrane fixed between a clumping plate and an adaptor plate so that no wrinkles occur, was measured according to JISP-8117. Measurement was repeated five times, and the average value was used as air permeability (sec/100 cc Air).

7. Coefficient of Contraction

A test piece was cut into 2.5 cm×7.5 cm, and sandwiched between two slide glasses, and heated at 150° C. for 10 minutes while a load was applied with a clip in such a degree that the test piece would not be curled. Sample after heating was collected and coefficient of contraction (%) was calculated according to the following formula.

Coefficient of contraction={(area of test piece before heating−area of test piece after heating)/area of test piece before heating}×100

8. Thickness of Membrane

Thickness of membrane was measured by using a contact-type thickness meter (digital micrometer M-30, available from SONY Manufacturing).

9. Puncture Strength

Using a compression tester (KES-G5 available from KATO TECH Co., Ltd.), puncturing test was conducted at a puncturing rate of 10 mm/s using a needle having a tip end with a radius of curvature of 0.5 mm, and the maximum puncturing load (gf) was defined as puncture strength (gt).

10. Porosity

Preparing a 10-cm-square sample, porosity (%) was calculated from the result obtained by measuring the volume (cm³) and mass (g) of the sample, according to the following formula.

Porosity=(1−mass/(resin density×sample volume))×100

11. Fabrication of Simple Button Battery and Measurement of Pore Blocking Temperature and Heat Resistant Membrane Breakage Temperature

85 parts by weight of lithium cobaltate powder, 5 parts by weight of carbon black, and 10 parts by weight of polyvinylidene fluoride were mixed, and added with N-methylpyrrolidone, and adjusted to a paste form. Then the paste was applied on aluminum foil having a thickness of 20 μm, dried, and pressed to fabricate a cathode plate. This was punched into a circle of 15.958 mm in diameter, to produce a cathode. Next, 90 parts by weight of mesophase carbon micro beads powder and 10 parts by weight of polyvinylidene fluoride were mixed, added with N-methylpyrrolidone, and adjusted to a paste form. Then the paste was applied on copper foil having a thickness of 18 μm, dried, and pressed to fabricate an anode plate. This was punched into a circle of 16.156 mm in diameter, to produce an anode.

The simple button battery fabricated in the manner as described was charged, and electric resistance at the time of discharging in the condition that it was dipped in an incubator equipped with thermostat function was measured, to thereby determine pore blocking temperature and heat resistant membrane breakage temperature. Silicon oil was used as heat medium.

12. Mass Average Molecular Weight and Molecular Weight Distribution

The composite porous membrane was impregnated with NMP so that porous membrane B was completely dissolved and sufficiently washed with NMP, and then dried at 100° C. for 12 hours in a vacuum drier. The obtained polyolefin porous membrane was measured by a gel permission chromatography (GPC) method at a flow rate of 1.0 mL/min. at a temperature of 135° C. using a GPC apparatus available from Waters Corporation, and GMH-6 available from TOSOH Corporation as a column, and o-dichlorobenzene as a solvent.

### Example 1

To 100 parts by weight of a polyamideimide resin solution (HR11NN available from TOYOBO Co., Ltd., concentration of nonvolatile content: 15% NMP solution, glass transition temperature: 280° C.), 20 parts by weight of polyethylene glycol (PEG-400 available from Sanyo Chemical Industries Ltd.) was added and mixed to homogeneity at room temperature (Coating solution 1).

After applying the coating solution 1 on the surface having preliminarily subjected to a corona discharge treatment of a propylene film (pi-wren-OT available from TOYOBO Co., Ltd.) which is a substrate with a clearance of 30 μm and application speed of 1.0 m/min, the film was caused to pass through the atmosphere of 80% RH at 25° C. over 30 seconds, to obtain porous membrane B in semi-gel state.

On the semi-gel porous membrane B, a polyethylene porous film (thickness: 20 μm, porosity: 40%, air permeability: 300 sec/100 cc Air) which is porous membrane A was laminated, and caused to enter in an aqueous solution containing 5% by weight of NMP, and then washed with pure water, and dried by passage through a hot blast drying section at 70° C., to obtain a composite porous membrane 1 as shown in FIG. 1.

### Example 2

To 100 parts by weight of a polyamideimide resin solution (HR16NN available from TOYOBO Co., Ltd., concentration of nonvolatile content: 14% NMP solution, glass transition temperature: 320° C.), 15 parts by weight of polyethylene glycol (PEG-400 available from Sanyo Chemical Industries Ltd.) was added and mixed to homogeneity at room temperature (Coating solution 2).

After applying the coating solution 2 on the surface having preliminarily subjected to a corona discharge treatment of the propylene film (pi-wren-OT available from TOYOBO Co., Ltd.) which is a substrate with a clearance of 20 μm and application speed of 1.0 m/min, the film was caused to pass through the atmosphere of 80% RH at 25° C. over 30 seconds, to obtain porous membrane B in semi-gel state.

On the semi-gel porous membrane B, the polyethylene porous film (thickness: 10 μm, porosity: 47%, air permeability: 80 sec/100 cc Air) which is porous membrane A was laminated. At this time, since tensile strength of polyethylene porous membrane was not sufficient, and necking was observed in the width direction, solidification, washing, and drying steps were conducted in the same manner as in Example 1 while the membrane was not peeled off the substrate film, and then the membrane was peeled off the substrate to give composite porous membrane 1 as shown in FIG. 1.

### Example 3

To a four-necked flask with a condenser and a nitrogen gas inlet, 0.5 mol of pyromellitic dianhydride, 0.5 mol of biphenyltetracarboxylic dianhydride, 0.5 mol of diphenylmethane-4,4′-diisocyanate and 0.5 mol of hexamethylene diisocianate were charged together with NMP so that solid concentration was 20%, and allowed to react at 150° C. for about one hour. The obtained solvent-soluble polyimide resin have a concentration of nonvolatile content of 20%, a logarithmic viscosity of 0.7 g/dl, and a glass transition temperature of 190° C. Composite porous membrane 1 as shown in FIG. 1 was obtained in the same manner as in Example 1 except that this polyimide resin solution was used.

### Example 4

To a four-necked flask with a condenser and a nitrogen gas inlet, 0.5 mol of terephthalic acid, 0.5 mol of isophthalic acid, and 1 mol of diphenylmethane-4,4′-diisocyanate were charged together with NMP so that solid concentration was 15%, and allowed to react for about one hour under stirring after increase in the temperature to 100° C. Temperature of this solution was raised to 150° C., and reaction was continued for about 3 hours. The obtained polyamide resin had a logarithmic viscosity of 0.8 dl/g, and a glass transition temperature of 270° C. Composite porous membrane 1 as shown in FIG. 1 was obtained in the same manner as in Example 1 except that this polyamide resin solution was used.

### Example 5

Composite porous membrane 1 as shown in FIG. 1 was obtained in the same manner as in Example 1 except that a solution that was obtained by dissolving a polyphenylene sulfide resin (Fortron KPS available from Kureha Corporation) in NMP so that concentration of nonvolatile content was 15% was used.

### Example 6

A polyamideimide resin solution (H11NN available from TOYOBO Co., Ltd., nonvolatile content concentration: 15% NMP solution, glass transition temperature: 280° C.) in polymer was injected from a nozzle diameter of 100 μm, and allowed to pass through an atmosphere of 25° C. and 80% RH over 20 sec, and dropped onto the surface having preliminarily subjected to a corona discharge treatment of the propylene film (pi-wren-OT available from Sanyo Chemical Industries Ltd.) which is a substrate. In this condition, NMP was not removed, and porous membrane B in gel (illiquid) state was obtained. On this porous membrane B in gel state, the polyethylene porous membrane which is porous membrane A was laminated in the same manner as in Example 2, followed by washing and drying steps, to obtain composite porous membrane 1 as shown in FIG. 1.

### Example 7

To 100 parts by weight of polyamideimide resin solution (HR11NN available from TOYOBO Co., Ltd., concentration of nonvolatile content: 15% NMP solution, glass transition temperature: 280° C.), 20 parts by weight of polyethylene glycol (PEG-400 available from Sanyo Chemical Industries Ltd.) was added, and mixed to homogeneity at room temperature. Using a reverse roll coater (applicator roll made of stainless φ 650 mm), the coating solution was made into gel (illiquid) by moisture absorption by keeping the section spanning subsequent to passage through a gap of 30 μm with respect to metering roll up to contacting with the polyethylene porous membrane in an atmosphere of 25° C. and 80% RH. Illiquid porous membrane B was transferred to the polyethylene porous membrane, and then solidification, washing and drying steps as is the same with Example 1 were conducted to obtain composite porous membrane 1 as shown in FIG. 1.

### Comparative Example 1

Using a polyethylene terephthalate resin film (available from TOYOBO Co., Ltd., thickness: 7 μm), pores were made by using laser. Porosity was 40%. Melting point was 265° C. Then polyethylene porous membrane (thickness: 20 μm, porosity: 40%, air permeability: 300 sec/100 cc Air) was heat deposited with the above PET film to produce a composite porous membrane.

### Comparative Example 2

A polyethylene porous membrane (thickness: 20 μm, porosity: 40%, air permeability: 300 sec/100 cc Air) was dipped into a solution that was prepared by adding 20 parts by weight of polyethylene glycol (PEG-400 available from Sanyo Chemical Industries Ltd.) to 100 parts by weight of a polyamideimide resin solution (HR11NN available from TOYOBO Co., Ltd., concentration of nonvolatile content: 15% NMP solution, glass transition temperature: 280° C.) and mixed to homogeneity at room temperature. As a measuring and smoothing jig, Mayer bar (No. 8, 20 mm in diameter, available from Yoshimitsu Seiki) was used. Air gap between two Mayer bars and solidification bath was set at 7 cm. Two Mayer bars were placed at a clearance of 40 μm so that the dipped porous membrane was located substantially in the middle between them. Thereafter, a prepared dope and solidification liquid was charged in a predetermined container, to get ready for membrane formation. The polyethylene porous membrane impregnated with the coating solution was caused to move at a rate of 3 m/min., and NMP was solidified, washed and dried in the same manner as in Example 1, to give composite porous membrane.

### Comparative Example 3

To 100 parts by weight of a polyamideimide resin solution (HR11NN available from TOYOBO Co., Ltd., concentration of nonvolatile content: 15% NMP solution, glass transition temperature: 280° C.), 30 parts by weight of polyethylene glycol (PEG-400 available from Sanyo Chemical Industries Ltd.) was added to prepare a coating solution. The above coating solution was directly applied on polyethylene porous membrane (thickness: 20 μm, porosity: 40%, air permeability: 300 sec/100 cc Air) with a clearance of 20 μm, and an applying rate of 1.0 m/min., and solidification, washing and drying steps were conducted in the same manner as in Example 1, to give composite porous membrane.

### Comparative Example 4

By heat depositing a stack of two polyethylene porous membranes (thickness: 10 μm, porosity: 47%, air permeability: 80 sec/100 cc Air), composite porous membrane composed exclusively of polyethylene was obtained.

### Comparative Example 5

On a polyethylene porous membrane (thickness: 10 μm, porosity: 47%, air permeability: 80 sec/100 cc Air), a stack of two polypropylene porous membranes (thickness: 20 μm, porosity: 50%, air permeability: 200 sec/100 cc Air) was heat deposited, to obtain a composite porous membrane of polyethylene and polypropylene.

### Comparative Example 6

To 100 parts by weight of polyamideimide resin solution (HR11NN available from TOYOBO Co., Ltd., concentration of nonvolatile content: 15% NMP solution, glass transition temperature: 280° C.), 30 parts by weight of polyethylene glycol (PEG-400 available from Sanyo Chemical Industries Ltd.) was added, to prepare a coating solution. The coating solution was applied on corona surface of a polyethylene terephthalate resin film (E5001 available from TOYOBO Co., Ltd.) with a clearance of 30 μm and an applying rate of 1.0 m/min., and caused to pass through an atmosphere of 25° C. and 80% RH over 30 seconds, to form a gel-like porous membrane, and further solidification, washing and drying steps similar to those in Example 1 were conducted to obtain a membrane composed solely of porous membrane B. The membrane composed solely of porous membrane B was wound around a paper tube together with polyethylene porous membrane (thickness: 20 μm, porosity: 40%, air permeability: 300 sec/100 cc Air) while it was caused to peel off the substrate.

### Comparative Example 7

Membrane composed solely of porous membrane B was produced in the same manner as in the above Comparative example, a resin solution obtained by dissolving polyvinilidene fluoride resin (KF polymer available from Kureha Corporation) in tetrahydrofuran so that concentration of nonvolatile content was 20%, and the obtained resin solution was applied to polyethylene porous membrane with a clearance of 10 μm, and an applying rate of 1.0 m/min., and then membrane solely formed of porous membrane B was laminated on a metal roll, and caused to pass through a hot blast section at 60° C. over 30 seconds, to obtain a composite porous membrane.

Results for Examples 1 to 7 are shown in Table 1, and results for Comparative examples 1 to 7 are shown in Table 2.

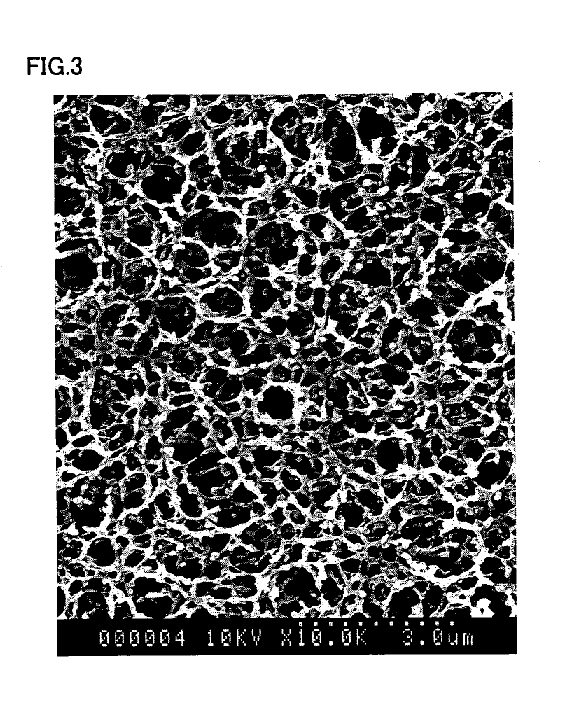

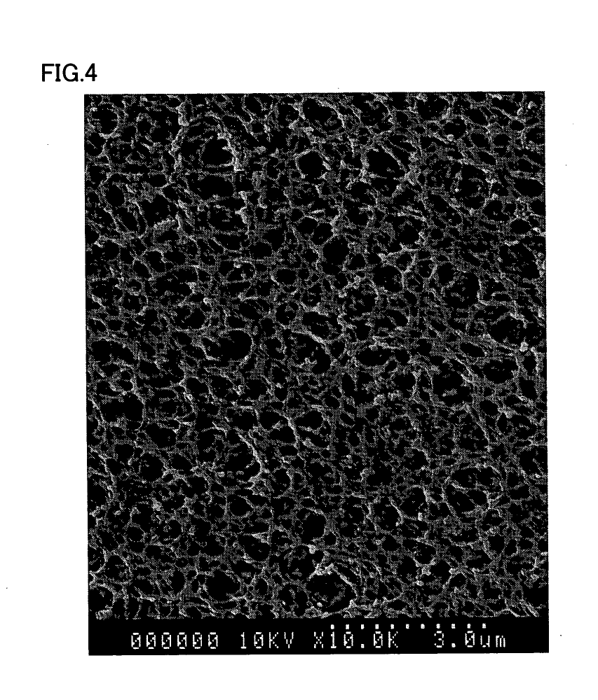

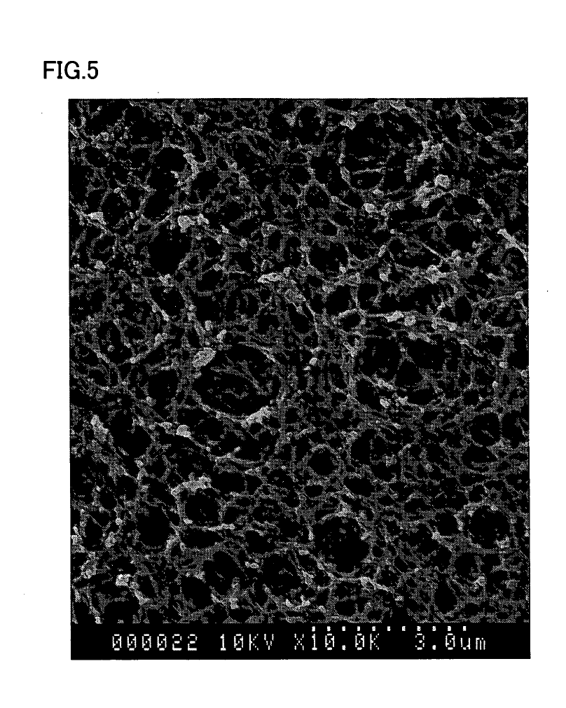

TABLE 1

| | | Example 1 | Example 2 | Example 3 | Example 4 | Example 5 | Example 6 | Example 7 |
|---|---|---|---|---|---|---|---|---|
| Porous membrane A | Thickness (μm) | 20 | 10 | 20 | 20 | 20 | 10 | 20 |
| (non-heat-resistant | Air permeability (sec/100 cc | 300 | 80 | 300 | 300 | 300 | 80 | 300 |
| phase) | Air) | | | | | | | |
| | Porosity (%) | 40 | 47 | 40 | 40 | 40 | 47 | 40 |
| | Mass average molecular weight | 47 | 32 | 47 | 47 | 47 | 32 | 47 |
| | (×10⁵) | | | | | | | |
| | Average pore size (μm) | 0.1 | 0.6 | 0.1 | 0.1 | 0.1 | 0.6 | 0.1 |
| Porous membrane B | Thickness (μm) | 5 | 4 | 5 | 4 | 8 | 18 | 4 |
| (heat-resistant | Logarithmic viscosity (dl/g) | 0.7 | 1.4 | 0.7 | 0.8 | 0.51 | 0.7 | 0.7 |
| phase) | Glass transition temperature | 280 | 320 | 190 | 270 | 220 | 280 | 280 |
| | (° C.) | | | | | | | |
| Composite porous | Thickness (μm) | 25 | 14 | 25 | 24 | 28 | 28 | 24 |
| membrane | Air permeability (sec/100 cc | 320 | 93 | 350 | 330 | 360 | 340 | 320 |
| | Air) | | | | | | | |
| | Porosity (%) | 48 | 56 | 48 | 47 | 51 | 68 | 47 |
| | Coefficient of contraction (%) | <2 | <1 | <2 | <1 | <3 | <5 | <2 |
| | Puncture strength (gf) | 470 | 200 | 470 | 470 | 470 | 480 | 470 |
| | Average pore size (μm) | 0.7 | 0.2 | 2.5 | 0.6 | 0.4 | 4.8 | 0.7 |
| | Occurrence of shunt at 200° C. | No | No | No | No | No | No | No |
| | Shutdown temperature (° C.) | 125 | 127 | 125 | 125 | 125 | 125 | 125 |
| | Occurrence of shunt during | No | No | No | No | No | No | No |
| | charging | | | | | | | |
| | SEM appearance (photograph) | FIGS. 2, 3 | — | — | FIGS. 4, 5 | — | FIGS. 6, 7 | — |

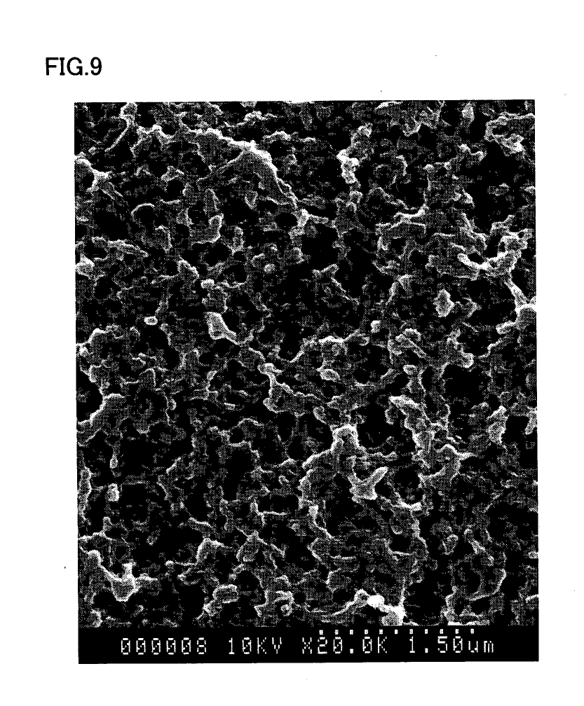

TABLE 2

| | | Comparative | Comparative | Comparative | Comparative | Comparative | Comparative | Comparative |
|---|---|---|---|---|---|---|---|---|
| | | example 1 | example 2 | example 3 | example 4 | example 5 | example 6 | example 7 |
| Porous membrane A | Thickness (μm) | 20 | 20 | 20 | — | — | 20 | 20 |
| (non-heat-resistant | Air permeability | 300 | 300 | 300 | — | — | 300 | 300 |
| phase) | (sec/100 cc Air) | | | | | | | |
| | Porosity (%) | 40 | 40 | 40 | — | — | 40 | 40 |
| | Mass average molecular | 47 | 47 | 47 | — | — | 47 | 47 |
| | weight (×10⁵) | | | | | | | |
| | Average pore size (μm) | 0.1 | 0.1 | 0.1 | — | — | 0.1 | 0.1 |
| Porous membrane B | Thickness (μm) | 7 | one side 4 | 5 | — | — | 9 | 9 |
| (heat-resistant | Logarithmic viscosity (dl/g) | 0.7 | 0.7 | 0.7 | — | — | 0.7 | 0.7 |
| phase) | Glass transition temperature | 280 | 280 | 280 | — | — | 280 | 280 |
| | (° C.) | | | | | | | |
| Composite porous | Thickness(μm) | 27 | 28 | 25 | 20 | 30 | 29 | 29 |
| membrane | Air permeability | 5000 | >10000 | 800 | 450 | 600 | 310 | 2500 |
| | (sec/100 cc Air) | | | | | | | |
| | Porosity (%) | 52 | 35 | 48 | 45 | 45 | 52 | 52 |
| | Coefficient of contraction | <1 | <1 | <1 | 7 | 5 | 7 | <2 |
| | (%) | | | | | | | |
| | Puncture strength (gf) | 1200 | 510 | 485 | 410 | 630 | 470 | 470 |
| | Average pore size (μm) | 32 | 1.5 | <0.1 | 0.1 | 0.2 | 0.3 | 0.3 |
| | Occurrence of shunt at | No | No | No | Yes | Yes | Yes | No |
| | 200° C. | | | | | | | |
| | Shutdown temperature | 152 | — | 135 | 125 | 127 | 125 | 137 |
| | (° C.) | | | | | | | |
| | Occurrence of shunt during | Yes | Yes | Yes | No | No | No | Yes |
| | charging | | | | | | | |
| | SEM appearance | — | FIG. 8 | FIG. 9 | — | — | — | — |
| | (photograph) | | | | | | | |

As a result, since porous membrane B is uniformly formed and is integrated so that it does not permeates inside porous membrane A in Examples 1 and 2, a decrease in air permeability was little observed, and charging and discharging at room temperature could be executed without any problem, and an increase in shutdown temperature or the like was not observed. This demonstrates that performance of porous membrane A using a polyethylene porous film that satisfies basic characteristics, as a separator is not deteriorated. Further, porous membrane B seems to be integrated in the condition that it is cut into convexoconcave on superior surface of porous membrane A, and as a result, it can be found that very large effect is exerted in contraction suppression in the horizontal direction for membrane.

In Examples 1 and 2, modulus of elasticity in wet membrane of heat resistant resin used in formation of porous membrane B differs, like 3000 MPa and 6000 MPa, and it can be seen that modulus of elasticity of resin itself contributes to reduction in melt contraction. In other word, as shown in Example 2, according to the present invention, sufficiently practicable safety is ensured even when a polyethylene porous membrane of 10 μm which is rarely used heretofore because of shortage of membrane breakage strength at high temperature is used. When a heat resistant resin used in formation of porous membrane B in Example 1 and a polyethylene porous film used as porous membrane A in Example 2 were combined, membrane breakage at high temperature was observed in part of test cells (data not shown).

Also in Examples 3 to 5, compositing was possible without causing deterioration in air permeability of porous membrane A using a polyethylene porous membrane. This reveals that composite porous membrane that will not break even at high temperature can be provided by compositing solvent-soluble type heat resistant resin besides a polyamideimide resin, with a polyolefin porous membrane by the production method of composite porous membrane of the present invention.

As for Example 6, deterioration in air permeability was observed in a level that is unobservable in conventional compositing method such as thermal compression bonding between the nonwoven fabric and tpolyolefin porous membrane, and compositing with the use of adhesive. Although examination for reducing the thickness of membrane was made, it was found that thickness of at least about 20 μm was required from the view point of uniformization of fiber diameter and pore distribution.

As for Example 7, it was the most advantageous method in terms of cost, and showed satisfactory performance which is comparable to that in Example 1.

On the other hand, in Comparative example 1, since pores that penetrate from superior side to back side are distributed and formed over wide range by the processing method with laser beams, dendrite frequently occurs due to heterogeneous reaction from the initial stage of charging. Although membrane breakage was not observed at 200° C. in test cells that could barely be produced experimentally, shunt that seems to be caused by dendrite occurred after charging and discharging of several times, so that object was not achieved. In this manner, dendrite is likely to occur especially in the part that is not reinforced by heat resistant porous membrane, and as a result, it can be found that safety is reduced compared to the polyethylene porous membrane.

As for Comparative example 2, since heat resistant resin penetrates and solidifies inside polyethylene, not only the porosity significantly decreases, but also air permeability deteriorates to unmeasurable level (measurement was stopped because of 10000 sec or more). Of course, membrane resistance was abnormally high compared with the polyethylene substrate alone, and the tendency that electric current concentrates in end part was observed, so that even charging was difficult.

As for Comparative example 3, processing in the condition that deterioration in air permeability was comparatively reduced was possible, although the object was not achieved. However, since the coating solution penetrates inside polyethylene likewise the case of Comparative example 2, the tendency that an increase in shutdown temperature was observed.

As for Comparative examples 4 and 5, it was impossible to impart heat resistance at 200° C. in any combinations, although they are well-known and widely used techniques.

As for Comparative example 6, since a decrease in air permeability was not observed, and charging and discharging at room temperature could be conducted with no problem, and a resin did not penetrate inside polyethylene, problem such as an increase in shutdown temperature was not observed. However, melt contraction occurred in the polyethylene porous membrane during temperature increase subsequent to shutdown temperature, and shunt occurred. This result shows that sufficient effect is not expressed unless the heat resistant resin layer is integrated with a polyolefin-type porous membrane.

In Comparative example 7, although uniform micropores are formed in both porous membranes, a part of adhesive layer blocks the pores in interfacial face between these porous membranes. Various examination revealed that the result tends to be close to that of Comparative example 6 when an amount of adhesive is reduced, while the result tends to be close to the that of Comparative example 2 when the quantity of adhesive material increases. Collation of this fact with results of Examples 1 to 6 demonstrates that mechanical anchoring effect by porous substance is the most effective bonding method between porous membranes.

According to the present invention, it is possible to provide a separator suited for a nonaqueous electrolyte secondary battery, realizing high membrane breakage temperature and high safety without impairing ion permeability and a low temperature pore blocking function that are inherently possessed by porous membrane A, so that contribution to industrial fields is great.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A composite porous membrane comprising a porous membrane A of a resin having a melting point of 150° C. or less and a porous membrane B of a resin having a glass transition temperature of more than 150° C. integrated with the porous membrane A, wherein both a superficial side of the porous membrane B and an interfacial side with the porous membrane A of the porous membrane B have a three-dimensional network structure.

2. The composite porous membrane according to claim 1, wherein a difference between pore blocking temperature and heat resistant membrane breakage temperature measured at a temperature increasing rate of 30° C./min is 50° C. or more, and the pore blocking temperature is 150° C. or less, and the heat resistant membrane breakage temperature is 200° C. or more.

3. The composite porous membrane according to claim 1, wherein the porosity of the porous membrane A is 30 to 70%, and the porosity of the porous membrane B is 30 to 90%.

4. The composite porous membrane according to claim 1, wherein the average pore size of the porous membrane A is 0.01 to 1.0 μm, and the average pore size of the porous membrane B is 0.1 to 5.0 μm.

5. The composite porous membrane according to claim 1, wherein the porous membrane A contains 50% by weight or more of ultrahigh molecular weight polyolefin having a mass average molecular weight of 3×10⁵ or more.

6. The composite porous membrane according to claim 1, wherein the porous membrane B is formed of at least one resin selected from the group consisting of a polyacetal resin, a polybutylene terephthalate resin, a polyethylene terephthalate resin, a polyphenylene sulfide resin, a polyether ketone resin, a polyetherimide resin, a fluorine resin, a polyether nitrile resin, a polycarbonate resin, a polyphenylene ether resin, a polysulfone resin, a polyether sulfone resin, a polyallylate resin, a polyimide resin, a polyamide imide resin, a polyamide resin and a cellulose resin.

7. The composite porous membrane according to claim 6, wherein the porous membrane B is formed of a polyamide resin, a polyimide resin or a polyamide imide resin having a logarithmic viscosity of 0.5 dl/g or more.

8. The composite porous membrane according to claim 1, wherein the porous membrane B is formed by a phase separation method.

9. A composite porous membrane comprising a porous membrane A of a resin having a melting point of 150° C. or less and a porous membrane B of a resin having a glass transition temperature of more than 150° C. integrated with the porous membrane A, wherein the air permeability of the entire composite porous membrane is twice or less the air permeability of the porous membrane A, and is in a range of 50 to 1000 sec/100 cc Air, and the total membrane thickness is 40 μm or less.

10. The composite porous membrane according to claim 9, wherein a difference between pore blocking temperature and heat resistant membrane breakage temperature measured at a temperature increasing rate of 30° C./min is 50° C. or more, and the pore blocking temperature is 150° C. or less, and the heat resistant membrane breakage temperature is 200° C. or more.

11. The composite porous membrane according to claim 9, wherein the porosity of the porous membrane A is 30 to 70%, and the porosity of the porous membrane B is 30 to 90%.

12. The composite porous membrane according to claim 9, wherein the average pore size of the porous membrane A is 0.01 to 1.0 μm, and the average pore size of the porous membrane B is 0.1 to 5.0 μm.

13. The composite, porous membrane according to claim 9, wherein the porous membrane A contains 50% by weight or more of ultrahigh molecular weight polyolefin having a mass average molecular weight of 3×10⁵ or more.

14. The composite porous membrane according to claim 9, wherein the porous membrane B is formed of at least one resin selected from the group consisting of a polyacetal resin, a polybutylene terephthalate resin, a polyethylene terephthalate resin, a polyphenylene sulfide resin, a polyether ketone resin, a polyetherimide resin, a fluorine resin, a polyether nitrile resin, a polycarbonate resin, a polyphenylene ether resin, a polysulfone resin, a polyether sulfone resin, a polyallylate resin, a polyimide resin, a polyamide imide resin, a polyamide resin and a cellulose resin.

15. The composite porous membrane according to claim 14, wherein the porous membrane B is formed of a polyamide resin, a polyimide resin or a polyamide imide resin having a logarithmic viscosity of 0.5 dl/g or more.

16. The composite porous membrane according to claim 9, wherein the porous membrane B is formed by a phase separation method.

17. A separator for a battery or a capacitor using the composite porous membrane according to claim 1.

18. A nonaqueous electrolyte secondary battery or a capacitor using the separator according to claim 17.

19. A separator for a battery or a capacitor using the composite porous membrane according to claim 9.

20. A nonaqueous electrolyte secondary battery or a capacitor using the separator according to claim 19.

21. A method of producing a composite porous membrane comprising the steps of: applying resin varnish having a glass transition temperature of more than 150° C. to a substrate; contacting the resin varnish with a poorer solvent than that contained in the varnish to make the resin varnish into a gel containing the solvent; transferring the gel to a porous membrane A of a resin having a melting point of 150° C. or less; and washing and drying the porous membrane A.

22. The method of producing a composite porous membrane according to claim 21, wherein the substrate is polypropylene, polyethylene, polyethylene terephthalate or stainless.

23. The method of producing a composite porous membrane according to claim 22, wherein polypropylene, polyethylene or polyethylene terephthalate is subjected to a corona discharge treatment.

24. The method of producing a composite porous membrane according to claim 21, wherein the substrate is in the form of an endless belt.

25. The method of producing a composite porous membrane according to claim 21, wherein a porous membrane B is formed by applying a resin solution capable of forming the porous membrane B to the substrate and making the substrate pass through an atmosphere at 10 to 30° C. and 50 to 90% RH over 10 to 60 seconds.
